(19) United States
(12) Patent Application Publication
(10) Pub. No.: US 2008/0058098 A1
(43) Pub. Date: Mar. 6, 2008

(54) SYSTEM AND METHOD FOR AWARDING A PROGRESSIVE PRIZE

(76) Inventors: Jerald C. Seelig, Absecon, NJ (US); Lawrence M. Henshaw, Hammonton, NJ (US)

Correspondence Address: IAN F. BURNS & ASSOCIATES, P.O. BOX 71115, RENO, NV, 89570, US

(21) Appl. No.: 11/844,120

(22) Filed: Aug. 23, 2007

Related U.S. Application Data
(60) Provisional application No. 60/824,008, filed on Aug. 30, 2006.

(51) Int. Cl. G06F 19/00; A63F 9/24

(52) U.S. Cl. 463/27

(57) ABSTRACT

In a progressive gaming system, a progressive prize winning event triggers the awarding of a primary progressive prize to at least one primary player. In addition, a secondary progressive prize is awarded to a subset of the current players. The secondary progressive prize may be awarded to selected current players, such as those players of a particular gaming device, or to players that have been playing for a predetermined period of time. In examples where the progressive game is played across multiple establishments, the secondary progressive prize may be awarded to a current player in a different establishment than that of the primary player to ensure the excitement and publicity of winning the progressive prize is spread across multiple establishments.

### CROSS REFERENCE TO RELATED APPLICATIONS

This application claims priority to U.S. provisional patent application Ser. No. 60/824,008, filed Aug. 30, 2006, the contents of which are herein incorporated by reference.

### FIELD OF THE INVENTION

The present invention relates to gaming systems and to methods of distributing prizes in gaming systems. More particularly, the present invention relates to gaming systems and methods involving progressive prizes.

### BACKGROUND OF THE INVENTION

Progressive gaming systems are known in the art. Generally, in a progressive gaming system a portion of each wager that is placed to play a game that includes a progressive prize is added to the progressive prize. Thus, the progressive prize increases over time as players place wagers and play for the prize. One or more meters are generally used to display the current amount of the progressive prize. When a progressive prize winning event occurs, the progressive prize is awarded to a player. A new progressive prize is started, generally at a seed value, and the progressive prize increases incrementally as wagers are placed for the progressive prize until another progressive prize winning event occurs.

Networked progressive gaming systems are also known in the art. These systems comprise a plurality of gaming devices that are linked to a central server by a communication network. The gaming devices may be in the same gaming establishment (e.g., casino) or they may be in different establishments. Each gaming device allows players to place a wager and play for a progressive prize. Since there are more gaming devices and more players contributing to the progressive prize, the progressive prize may increase faster and reach a larger amount.

Progressive prize systems may include, for example, a series of slot machines that are played by players providing individual wagers to individual machines, that is, without interaction between players. A portion of each wager may be allocated to a progressive prize pool. Each machine can award individual prizes in response to appropriate triggers. In addition, each machine can generate a prize winning event that results in the progressive prize being awarded.

In alternative systems, a progressive prize system may be based on a game played collectively by a group of players, such as a bingo game, lottery, or the like. For example, in a lottery system, players may wager a ticket price to purchase a ticket number. The wagers collectively form the prize pool, a first portion of which is allocated to the current game prize pool and a second portion of which may be allocated to a progressive prize pool. A single game may include the first step of selecting a group of ticket numbers as winners, with the current game prize pool being distributed amongst the winning ticket holders. Then a second step may including selecting one number from all of the original ticket numbers, with the payment of the progressive prize pool being triggered if the selected number matches a winning ticket number from the first step. In this system, the current game prize pool is awarded each game, whereas the progressive prize pool is only awarded if the specific trigger condition is met.

It will be readily understood that the term “player” as used herein and throughout the specification does not necessarily refer to an individual person and may include individuals or groups of individuals such as a syndicate, as is well known in the field.

Prior art progressive gaming systems generally only award a progressive prize pool to one player in one establishment. When a player wins the progressive prize, generally the entire prize is awarded to that player. Such a system may provide a disincentive to players for a number of reasons. First, many players are discouraged from playing progressive systems because they generally have a low probability of winning the progressive prize, especially for large systems where the win rate is designed to be very low. Second, the publicity associated with the awarding of the progressive prize is limited to the single player. Furthermore, only one establishment can experience the excitement and publicity generated by a progressive prize win.

U.S. Pat. No. 6,887,154 (Luciano, Jr. et al.) describes a progressive gaming system in which, in conjunction with a primary progressive jackpot prize, a secondary progressive jackpot prize is awarded to all active players within a network of gaming devices. However by distributing a secondary progressive jackpot prize amongst all active players, the system described in U.S. Pat. No. 6,887,154 remains relatively inflexible.

### ADVANTAGES OF ONE OR MORE EMBODIMENTS OF THE PRESENT INVENTION

The various embodiments of the present invention may, but do not necessarily, achieve one or more of the following advantages:

the ability to award a progressive prize to at least one primary winner as well as at least one secondary winner;

the ability to flexibly and/or dynamically determine a subset of current players to receive a secondary progressive prize;

provide an increased incentive for players to utilize a progressive gaming system;

reward other players who may have played on the progressive system for a longer period of time;

provide a greater number of winners of a progressive prize;

provide greater positive publicity regarding a progressive prize winning event;

provide an increased number of repeat players; and

where the gaming system is distributed across more than one establishment, generate excitement and positive publicity regarding a progressive prize winning event in more than one establishment.

These and other advantages may be realized by reference to the remaining portions of the specification, claims, and abstract.

### SUMMARY OF THE INVENTION

In one embodiment, the invention resides in a method for gaming comprising receiving a plurality of wagers from a plurality of players; allocating at least a portion of said plurality of wagers to a progressive prize; determining a progressive prize winning event; determining at least one primary player associated with said progressive prize winning event; awarding a primary portion of said progressive prize to said at least one primary player; determining the current players; selecting a subset of the current players; and awarding a secondary portion of said progressive prize to the subset of current players.

In a further embodiment, the invention resides in a gaming system comprising at least one gaming device for receiving a plurality of wagers from a plurality of players; means for allocating at least a portion of said plurality of wagers to a progressive prize; means for determining a progressive prize winning event; means for determining at least one primary player associated with said progressive prize winning event; means for awarding a primary portion of said progressive prize to said at least one primary player; means for determining the current players; means for selecting a subset of the current players; and means for awarding a secondary portion of said progressive prize to the subset of current players.

In a further embodiment, the invention resides in a computer system for controlling a gaming system comprising at least one processor, and at least one computer readable medium comprising instructions executable on said at least one processor, said instructions comprising instructions for determining a progressive prize winning event; determining at least one primary player associated with said progressive prize winning event; awarding a primary portion of said progressive prize to said at least one primary player; determining the current players; selecting a subset of the current players; and awarding a secondary portion of the progressive prize to the subset of current players.

The above description sets forth, rather broadly, a summary of embodiments of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 substantially represents a progressive gaming system;

FIG. 2 substantially represents a first configuration of a progressive gaming system;

FIG. 3 substantially represents a second configuration of a progressive gaming system;

FIG. 4 substantially represents a flow chart showing a progressive gaming system method in accordance with an embodiment of the invention; and

FIG. 5 substantially represents a flow chart showing a progressive gaming system method in accordance with a further embodiment of the invention.

### DETAILED DESCRIPTION OF PREFERRED EMBODIMENTS

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

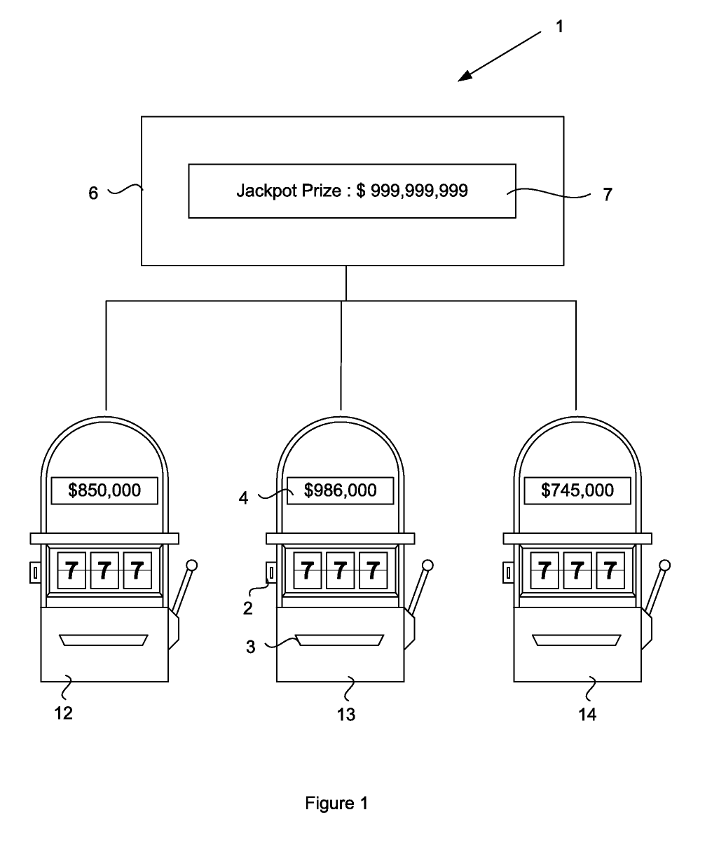

One way gaming device manufactures have added additional enjoyment and excitement to gaming devices is through the advent of progressive gaming. Progressive games have become very popular in casinos. In FIG. 1, there is shown a network 1 of progressive gaming apparatuses 12, 13, and 14. The gaming apparatus are shown, by way of example, as slot machines, though it will be recognized by the skilled addressee that many forms of gaming apparatus will be suitable. Each slot machine, e.g. slot machine 13, includes a coin slot 2 for receiving wagers such as coins or tokens and a payout slot 3 through which winnings may be paid. Progressive slot machines contain jackpots that increase every time a player places a wager in a primary game of the slot machine. Progressive jackpots involve one or more gaming machines. For example, an individual progressive slot machine 13 has a self-contained jackpot, e.g. jackpot 4, wherein the jackpot grows with every play of that machine. A progressive network, such as shown in FIG. 1, includes two or more slot machines 12, 13, and 14 at the same or different locations connected to a common jackpot 7, shown on display 6, each of which slot machines 12, 13, and 14 individually contribute to the common jackpot 7. Gaming machines usually take a percentage of the player's wager, such as 2%, and add it to the progressive jackpot. This allows the progressive jackpot to grow over time. Progressive jackpots can reach sizeable amounts, such as multi-million dollar jackpots, before a player “hits” or wins the progressive jackpot.

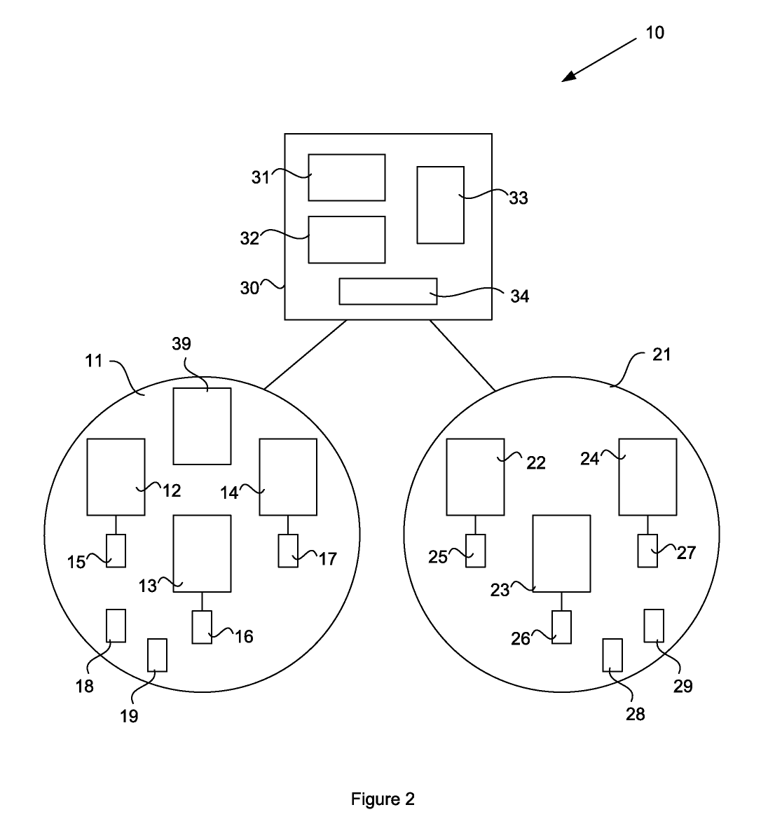

A gaming system 10 in accordance with an embodiment of the invention is at least partially shown in FIG. 2. Gaming system 10 includes gaming devices 12, 13, and 14 as a first set of gaming devices operated by a first set of current players 15, 16, and 17 respectively at a first establishment 11. A second establishment 21 has a second set of gaming devices 22, 23, and 24 operated by a second set of current players 25, 26, and 27. First establishment 11 may be in communication with second establishment 21 through a computer system 30. The communication may be facilitated by a number of different devices, such as a computer network. The computer system 30 includes at least one processor 31, a memory 32 storing an instruction set executable on the processor 31, a database 33 and one or more servers 34. Servers 34 provide communications to establishments 11 and 21 for controlling a progressive gaming system. The gaming system of FIG. 1 demonstrates an example in which players participate in a game through individual gaming devices. An example of a gaming system of the type illustrated in FIG. 2 is a networked series of slot machines or similar gaming machines. Other equivalent examples, however, will be readily apparent to the skilled addressee and are considered to fall within the scope of the invention. In accordance with known networked progressive gaming systems, each time a player, such as player 15, provides a wager to a gaming device, for example gaming device 12, a portion of the wager is allocated to a progressive prize. This process is repeated for all players across all gaming devices that make up the progressive gaming system.

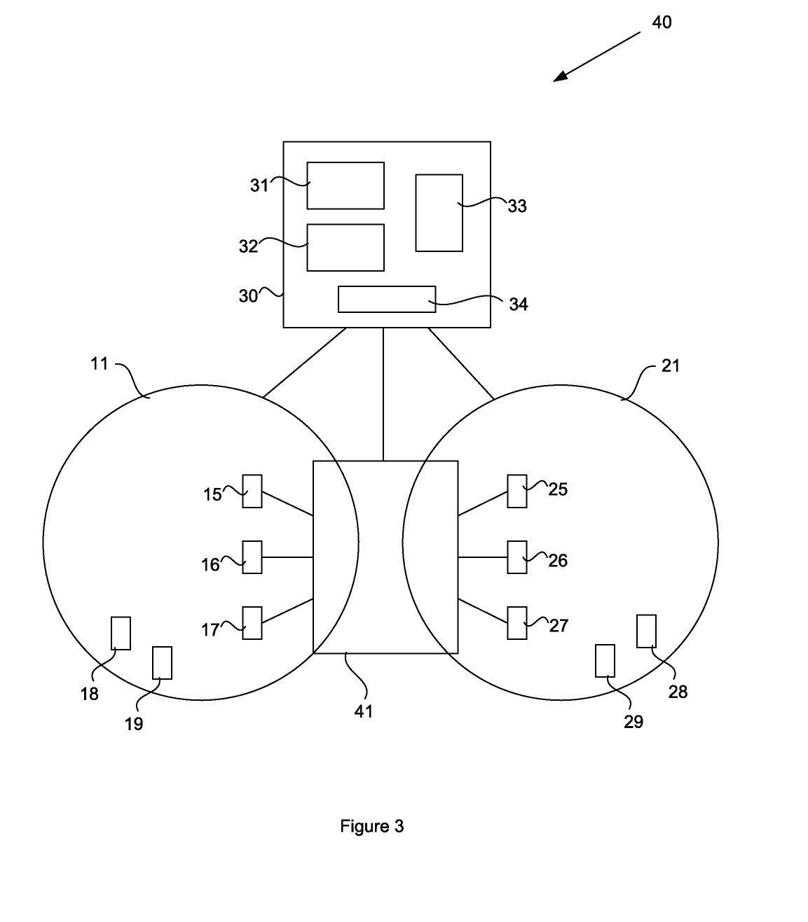

An alternative gaming system 40 is shown in FIG. 3 in which a single game is collectively played by multiple players simultaneously. In the gaming system 40, current players 15, 16, and 17 within establishment 11 and current players 25, 26, and 27 within establishment 21 each wager on the same game 41 under the control of computer system 30. The rules of game 41 determine when a progressive prize winning event is triggered. An example of a collective gaming system 40 may be the lottery game described above. Other equivalent examples, however, will be readily apparent to the skilled addressee and are considered to fall within the scope of the invention.

The term current player is used herein to denote a player active on a gaming device and/or participating in a game, which may be an individual game or a collective game. The term current player is used to distinguish from other players who may have played the progressive game at another time and have therefore wagered towards the progressive prize. By way of illustration, FIG. 2 shows gaming system 39 which has no associated current player.

In accordance with an embodiment of the present invention, the progressive prize pool is divided between a primary progressive prize and a secondary progressive prize. The primary progressive prize may be displayed on first displays 18 and 28 in the first and second establishments 11 and 21, respectively, while the secondary progressive prize pool may be displayed on respective displays 19 and 29 within first and second establishments 11 and 21. Alternatively, one or both of the progressive prizes may be unknown to the players. The primary progressive prize may be of a greater or lesser value than the secondary progressive prize.

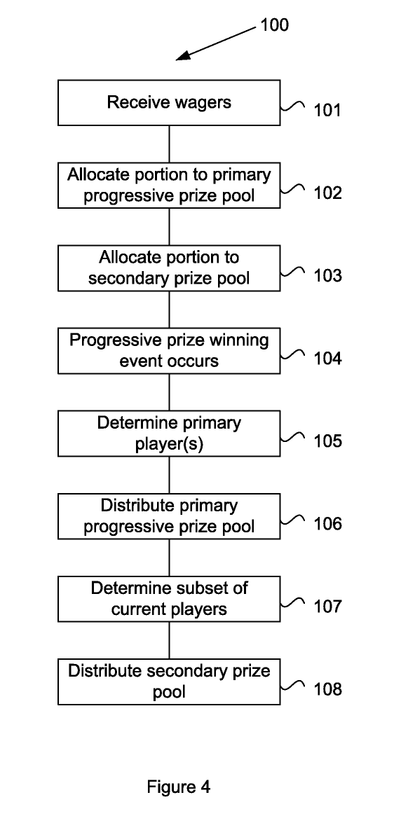

The operation of a progressive gaming system in accordance with the invention will now be described with reference to the flow chart 100 of FIG. 4. The type of progressive gaming system is not essential to the method and may be based on the individual gaming system 10 of FIG. 2, the collective gaming system 40 of FIG. 3, or any suitable progressive gaming system. A progressive gaming system receives a plurality of wagers (step 101) through one or more gaming devices. A portion of the wagers are allocated to a primary progressive prize (step 102) while a further portion of the wagers are allocated to a secondary progressive prize (step 103). Occasionally, a progressive prize winning event occurs (step 104). The progressive prize winning event may be generated within the gaming system, for example from within a gaming device or may be externally generated. The progressive prize winning event is determined to be associated with a primary player or players (step 105), to whom the primary progressive prize pool is distributed (step 106). The progressive prize winning event is then determined to be further associated with a subset of the current players (step 107), to whom the secondary progressive prize pool is distributed (step 108).

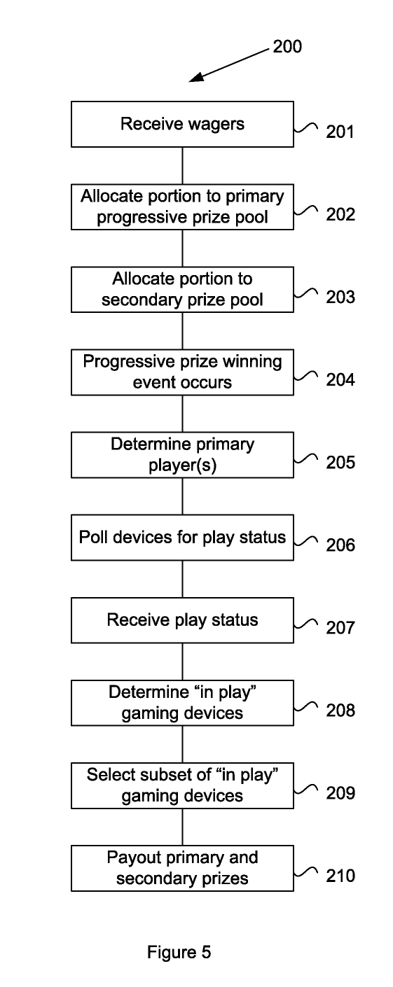

A specific example utilizing the gaming system 10 represented by FIG. 2 will now be described with reference to the flowchart 200 of FIG. 5. In gaming system 10, each of the gaming devices 12, 13, 14, 22, 23 and 24 receives wagers from players over time (step 201). A portion of those wagers are allocated to a primary progressive prize (step 202) and a secondary progressive prize (step 203). At any point in time, a specific gaming device, e.g. gaming device 12, may generate a progressive prize winning event (step 204). The gaming device 12, hereinafter the primary gaming device, may then send a signal to central computer system 30 communicating the progressive prize winning event. Having received the progressive prize winning event from gaming device 12, computer system 30, by way of processor 31, determines that the primary progressive prize is to be awarded to player 15 (step 205), being the player associated with primary gaming device 12. Processor 31 then polls each gaming device for a play status (step 206) through servers 34 and after receiving responses from each gaming device (step 207), determines which of the gaming devices are “in play” (step 208). A gaming device may be defined as “in play” (i.e., the gaming device is currently being played) in a number of different ways. For example, a gaming device may be in play if: 1) it is currently in a game cycle, 2) a game cycle has been completed within a certain period of time, 3) credits are currently on the gaming device's meter (virtual bank) and are available to be played, or 4) a player has logged on to the gaming device or otherwise identified herself, such as through a player tracking system (not shown) operating in conjunction with player identities stored in database 33 of computer system 30. Other methods for determining the play status of a gaming device will be apparent to the skilled addressee, and all relevant substitutions for the above examples are intended to be encompassed herein.

Once the play status of the gaming devices is known, processor 31 can select the subset of current players to whom a secondary progressive prize can be awarded (step 209). Examples for selecting the secondary players are described in more detail below. Payouts of both the primary and secondary progressive prizes can then be made (step 210). In accordance with known payout systems, payouts of both the primary and secondary progressive prizes may be made directly through the gaming devices, direct to the players, or through other means.

In one embodiment, the subset of secondary progressive prize winning player(s) is selected from the current players with or without the exception of the primary prize winner(s). For a gaming system of the type represented by FIG. 2, a current player may be any player associated with an “in play” device. For a gaming system of the type represented by FIG. 3, in which current players are not associated with individual gaming devices but play through a collective gaming device, the current players may be determined by other means, such as a registration of players stored in database 33 of computer system 30. For example, in a lottery game, a player's identity may be registered in association with their ticket number(s) and in association with a game number.

In one embodiment, the subset of current players to whom a secondary progressive prize is awarded are those players who are playing one or more specifically designated linked gaming devices. For example, gaming devices 13 and 23 in gaming system 10 of FIG. 2 may be designated as secondary prize gaming devices. The designation may be made apparent to players through signs or displays, or it may be unknown to players. If a second player is playing a designated secondary prize gaming device when the first player wins the primary progressive prize, the second player would be awarded a secondary progressive prize. The designation may be dynamic to ensure that the designated gaming device is an in-play gaming device. For example, if player 16 at gaming device 13 were to vacate the gaming device 13, the gaming device 13 may become inactive. The gaming system 10 would then adjust by designating an in-play gaming device, e.g. gaming device 14, to be within the subset of gaming devices that are eligible to win the secondary progressive prize. This embodiment has an advantage in that players who are aware that they are playing a gaming device designated to win the secondary progressive prize have a greater incentive to remain playing for a longer period.

In one embodiment, a subset of in-play gaming devices is randomly selected from all in-play gaming devices, and the players that are playing the selected devices are awarded the secondary progressive prize.

In one embodiment, the awarding of the secondary progressive prize may be dependent on the primary gaming device. For example, if the primary gaming device is gaming device 12 shown in FIG. 2, the subset of current players may be chosen by the gaming system 10 to be only gaming device 13, which is immediately adjacent gaming device 12. In a further example, the subset of in-play gaming devices may be all gaming devices within the same establishment as the primary gaming device. That is, for the example in which gaming device 12 is the primary gaming device, the secondary progressive prize may be distributed to the gaming devices 13 and 14 within establishment 11. Alternatively, the gaming system 10 may specify that at least one of the subset of in-play gaming devices must be selected from an establishment outside that of the primary gaming device. This embodiment provides the advantage that the excitement of winning the progressive prize is experienced in a plurality of establishments rather than just one.

In one embodiment, the subset of current players to whom a secondary progressive prize is awarded may be selected based on a time of play, determined by the amount of time for which a gaming device has been in play. For example, the subset of current players may be those players that have been playing at a gaming device for longer than a predetermined period of time, e.g. one hour. Alternatively, the subset of current players may be the player who has been playing at a gaming device for the longest period of time. In a collective game, the subset of current players may be the players who have played at least a predetermined number of consecutive games, determined from a registration of a player's identity. Alternatively, the subset of current players may be the player who has played the highest number of consecutive games.

The person skilled in the art will readily understand that alternative methods for determining the secondary progressive prize winners are available, including, but not limited to, a combination of two or more of the methods described above.

Several methods for generating a prize winning event will be apparent to the skilled addressee. For example, a prize winning event may be determined by each gaming device independently. In one specific example, each time a wager is placed for a progressive prize and play is commenced, a random number generator generates a random number and compares it to a pay table. If the random number falls within a predetermined winning range of numbers, a prize winning event has occurred. The gaming device may then send a signal to the central server communicating the prize winning event. The specific method for generating the prize winning event, however, is not considered essential to the invention, and all equivalent methods are intended to be encompassed herein.

The amount of the secondary progressive prize may be determined in different ways. In one embodiment, the secondary progressive prize is a fixed amount. For example, each player that qualifies to receive the secondary progressive prize is awarded $1,000. In another embodiment, the secondary progressive prize is a fixed percentage of the primary progressive prize. For example, each player that qualifies to win the secondary progressive prize is awarded five percent of the primary progressive prize. In order to meet regulatory requirements or to accurately control the amounts that are awarded in this embodiment, it may be necessary to limit the number of secondary prizes to a specific number (e.g., two). In another embodiment, secondary progressive prizes are a percentage of the primary progressive prize divided by the number of players to receive a secondary progressive prize. For example, if the primary progressive prize is one million dollars and the secondary prize percentage is 10%, then the total secondary progressive prize is $100,000. If 50 players were eligible to win the secondary progressive prize at the time the primary progressive prize was won, then each of the 50 player would receive a $2,000 secondary progressive prize.

The progressive prizes of the present invention may be funded in different ways. In one embodiment, a percentage of each eligible wager is contributed to the primary prize and to the secondary prize. For example, two percent of each wager may be contributed to the primary prize and one percent of each wager may be contributed to the secondary prize. In the embodiment in which the secondary prize is a percentage of the primary prize, the contributions may be in proportion to the percentage. Contributions to the secondary prize may come from all linked gaming devices or only from designated gaming devices. In the embodiment in which there is a designated secondary prize gaming device, contributions may come only from that gaming device.

The subset of current players selected to win the secondary progressive prize may have as little as one player up to, but not including, all of the current players.

While examples of progressive gaming systems are provided above, the person skilled in the art will readily understand that the details of the particular progressive game are not essential to the workings of the present invention, which may be applied to any suitable progressive gaming system by awarding a secondary progressive prize to at least one secondary progressive prize winner.

While the invention has been described with reference to embodiments in which the progressive prize gaming system is distributed across multiple establishments, the person skilled in the art will readily recognize that the systems and methods of the present invention may be implemented within a single establishment. Furthermore, the progressive gaming system may be implemented and distributed on a wide area network, such as the internet, without any physical establishment being identifiable. In such an embodiment, a gaming device may be considered to be a user's computer station.

The invention has been described with specific reference to a two-level structure for the awarding of a progressive prize, i.e. the progressive prize is awarded on a primary and secondary level. The person skilled in the art will readily recognize that the invention may be extended to any greater number of levels without departing from the scope of the invention.

The person skilled in the art will readily understand that the sequence of steps shown in the figures is provided for illustrative purposes only and that the order of steps is not essential. Furthermore, the person skilled in the art will recognize that a greater or lesser number of steps may be performed without departing from the scope of the invention.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A method for gaming comprising:
(A) receiving a plurality of wagers from a plurality of players;
(B) allocating at least a portion of said plurality of wagers to a progressive prize;
(C) determining a progressive prize winning event;
(D) determining at least one primary player associated with said progressive prize winning event;
(E) awarding a primary portion of said progressive prize to said at least one primary player;
(F) determining current players;
(G) selecting a subset of said current players; and
(H) awarding a secondary portion of said progressive prize to said subset of current players.

2. The method of claim 1 wherein allocating at least a portion of said plurality of wagers to a progressive prize comprises allocating a portion of said plurality of wagers to at least one primary progressive prize and allocating a portion of said plurality of wagers to at least one secondary progressive prize.

3. The method of claim 1 wherein said secondary portion of said progressive prize is awarded to each player of said subset of current players.

4. The method of claim 1 wherein said secondary portion of said progressive prize is awarded to each player of said subset of current players, excluding said at least one primary player.

5. The method of claim 1 wherein said plurality of wagers are received through a plurality of gaming devices, wherein each current player is associated with a gaming device and wherein determining said subset of current players comprises determining a play status of each of said gaming devices.

6. The method of claim 5 wherein selecting said subset of current players comprises selecting a subset of gaming devices having an in-play status.

7. The method of claim 6 wherein said subset of gaming devices having an in play status is randomly selected.

8. The method of claim 6 wherein said subset of gaming devices having an in play status is predetermined.

9. The method of claim 1 wherein selecting said subset of current players is dependent on said at least one primary player.

10. The method of claim 9 wherein at least one of said subset of current players is selected to be from an establishment different from an establishment of said at least one primary player.

11. A gaming system comprising:
(A) at least one gaming device means receiving a plurality of wagers from a plurality of players;
(B) means for allocating at least a portion of said plurality of wagers to a progressive prize;
(C) means for determining a progressive prize winning event;
(D) means for determining at least one primary player associated with said progressive prize winning event;
(E) means for awarding a primary portion of said progressive prize to said at least one primary player;
(F) means for determining current players;
(G) means for selecting a subset of said current players; and
(H) means for awarding a secondary portion of said progressive prize to said subset of current players.

12. The gaming system of claim 11 comprising a plurality of said gaming device means wherein said means for determining current players comprises means for determining a play status of said plurality of gaming devices means.

13. The gaming system of claim 12 wherein said means for selecting a subset of current players comprises means for selecting a subset of gaming device means having an in-play status.

14. The gaming system of claim 13 wherein said plurality of gaming device means are disposed in a plurality of establishments; wherein said primary player is associated with a primary gaming device means and wherein said means for selecting a subset of gaming device means comprises means for selecting at least one gaming device means dependent on the establishment in which said primary gaming device means is disposed.

15. The gaming system of claim 14 wherein said means for selecting a subset of gaming device means selects at least one gaming device means from at least one establishment different from the establishment in which said primary gaming device means is disposed.

16. A progressive gaming system, comprising:
(A) a plurality of gaming devices, each gaming device allowing a player to place a wager and play a game;
(B) a processor in communication with each of the gaming devices, the processor configured to:
(a) detect occurrence of a progressive prize winning event;
(b) determine at least one primary player associated with said progressive prize winning event;
(c) award a primary portion of said progressive prize to said at least one primary player;
(d) determine current players;
(e) select a subset of said current players; and
(f) award a secondary portion of said progressive prize to said subset of current players.

17. The progressive gaming system of claim 16 wherein detecting occurrence of a progressive prize winning event comprises receiving a progressive prize winning event from at least one gaming device.

18. The progressive gaming system of claim 16 wherein said processor is configured to select a subset of current players dependent on said at least one primary player.

19. The progressive gaming system of claim 18 wherein said processor is configured to select a subset of current players comprising at least one player located in an establishment different to an establishment of said at least one primary player.

20. The progressive gaming system of claim 18 wherein the selection of said subset of current players is predetermined.
